(19) United States
(12) Patent Application Publication
(10) Pub. No.: US 2006/0041335 A9
(43) Pub. Date: Feb. 23, 2006

(54) Apparatus and method for servicing vapor compression cycle equipment

(76) Inventors: Todd M. Rossi, Princeton, NJ (US); Dale Rossi, Limerick, PA (US); Jonathan D. Douglas, Lawrenceville, NJ (US); Timothy P. Stockman, Ivyland, PA (US)

Correspondence Address: LAW OFFICES OF MARK A. GARZIA, P.C., 2058 CHICHESTER AVE, BOOTHWYN, PA, 19061, US

(21) Appl. No.: 10/313,918

(22) Filed: Dec. 4, 2002

Related U.S. Application Data
(63) Continuation-in-part of application No. 09/939,012, filed on Aug. 24, 2001, now Pat. No. 6,658,373.
(60) Provisional application No. 60/290,433, filed on May 11, 2001.
(60) Provisional application No. 60/313,289, filed on Aug. 17, 2001.

(51) Int. Cl. G05B 15/00

(52) U.S. Cl. 700/276

(57) ABSTRACT

An apparatus and method for detecting faults and providing diagnostic information in a refrigeration system comprising a microprocessor, a means for inputting information to the microprocessor, a means for outputting information from the microprocessor, and five sensors. It is emphasized that this abstract is provided to comply with the rules requiring an abstract that will allow a searcher or other reader to quickly ascertain the subject matter of the technical disclosure. It is submitted with the understanding that this abstract will not be used to interpret or limit the scope or meaning of the claims.

### CROSS REFERENCE TO RELATED APPLICATIONS

The present application claims the benefit of U.S. Provisional Application No. 60/313,289 filed Aug. 17, 2001, entitled VAPOR COMPRESSION CYCLE FAULT DETECTION AND DIAGNOSTICS in the name of Todd Rossi, Dale Rossi and Jon Douglas.

U.S. Provisional Application No. 60/313,289, filed Aug. 17, 2001, is hereby incorporated by reference as if fully set forth herein.

### FIELD OF THE INVENTION

The present invention relates generally to an apparatus and a method for servicing an air-conditioning system. More particularly, the present invention relates to an apparatus and a method for servicing an air-conditioning system, which utilizes a data acquisition system for communicating with the air-conditioning system and a hand-held computer, which analyzes the information, received from the data acquisition system.

### BACKGROUND OF THE INVENTION

Air conditioners, refrigerators and heat pumps are all classified as HVAC&R systems. The most common technology used in all these systems is the vapor compression cycle (often referred to as the refrigeration cycle), which consists of four major components (compressor, expansion device, evaporator, and condenser) connected together via a conduit (preferably copper tubing) to form a closed loop system. The term refrigeration cycle used in this document refers to the vapor compression cycle used in all HVAC&R systems, not just refrigeration applications.

Light commercial buildings (e.g. strip malls) typically have numerous refrigeration systems located on their rooftops. Since servicing refrigeration systems requires highly skilled technician to maintain their operation, and there are few tools available to quantify performance and provide feedback, many of refrigeration cycles are poorly maintained. For example, two common degradation problems found in such commercial systems are fouling of the evaporator and/or condenser by dirt and dust, and improper refrigerant charge.

In general, maintenance, diagnosis and repair of refrigeration systems are manual operations. The quality of the service depends almost exclusively upon the skill, motivation and experience of a technician trained in HVAC&R. Under the best circumstances, such service is time-consuming and hit-or-miss opportunities to repair the under-performing refrigeration system. Accordingly, sometimes professional refrigeration technicians are only called upon after a major failure of the refrigeration system occurs, and not to perform routine maintenance on such systems.

The tools that the technician typically uses to help in the diagnosis are pressure gauges, service units which suggest possible fixes, common electronic instruments like multi-meters and component data books which supplement the various service units that are available. Even though these tools have improved over the years in terms of accuracy, ease of use and reliability, the technician still has to rely on his own personal skill and knowledge in interpreting the results of these instruments. The problems associated with depending upon the skill and knowledge of the service technician is expected to compound in the future due in part to the introduction of many new refrigerants. Thus, the large experience that the technicians have gained on current day refrigerants will not be adequate for the air-conditioning systems for the future. This leads to a high cost for training and a higher incident of misdiagnosing which needs to be addressed. During the process of this diagnosis by the technician, he typically relies on his knowledge and his past experience. Thus, accurate diagnosis and repair require that the technician possess substantial experience. The large number of different air-conditioning systems in the marketplace complicates the problem of accurate diagnosis. While each air-conditioning system includes a basic air-conditioning cycle, the various systems can include components and options that complicate the diagnosis for the system as a whole. Accordingly, with these prior art service units, misdiagnosis can occur, resulting in improperly repaired systems and in excessive time to complete repairs.

Although service manuals are available to assist the technician in diagnosing and repairing the air-conditioning systems, their use is time-consuming and inefficient. In addition, the large number of manuals requires valuable space and each manual must be kept up to date. Attempts to automate the diagnostic process of HVAC&R systems have been made. However, because of the complexity of the HVAC&R equipment, high equipment cost, or the inability of the refrigeration technician to comprehend and/or properly handle the equipment, such diagnostic systems have not gained wide use.

### SUMMARY OF THE INVENTION

The present invention includes an apparatus and a method for fault detection and diagnostics of a refrigeration, air conditioning or heat pump system operating under field conditions. It does so by measuring, for each vapor compression cycle, at least five—and up to nine—system parameters and calculating system performance variables based on the previously measured parameters. Once the performance variables of the system are determined, the present invention provides fault detection to assist a service technician in locating specific problems. It also provides verification of the effectiveness of any procedures performed by the service technician, which ultimately will lead to a prompt repair and may increase the efficiency of the refrigeration cycle.

The subject data acquisition system coupled with a hand held computer using sophisticated software provides a reasonable cost diagnostic tool for a service technician. In the very cost sensitive systems like residential air-conditioning system, this diagnostic tool eliminates the need for having each system equipped with independent sensors and electronics, yet they will still have the capability to assist the technician to efficiently service the air-conditioning system when there is a problem.

The diagnostic tool may also include a wireless Internet link with a master computer which contains the service information on all of the various systems in use. In this way, the hand held computer can be constantly updated with new information as well as not being required to maintain files on every system. If the technician encounters a system not on file in his hand held computer, a wireless Internet link to the master computer can identify the missing information.

The present invention is intended to be used with any manufacturer's HVAC&R equipment, is relatively inexpensive to implement in hardware, and provides both highly accurate fault detection and dependable diagnostic solutions which does not depend on the skill or abilities of a particular service technician.

### BRIEF DESCRIPTION OF THE DRAWINGS

The accompanying drawings, which are incorporated in and form a part of the specification, illustrate the embodiments of the present invention and, together with the following description, serve to explain the principles of the invention. For the purpose of illustrating the invention, there are shown in the drawings embodiments which are presently preferred, it being understood, however, that the invention is not limited to the specific instrumentality or the precise arrangement of elements or process steps disclosed.

In the drawings:

FIG. 1 is a block diagram of a conventional refrigeration cycle;

FIG. 2 schematically illustrates an air-conditioning service system in accordance with the present invention; and

FIG. 3 schematically illustrates the air-conditioning service system shown in FIG. 2 coupled with the air-conditioning system shown in FIG. 1.

FIG. 4 is a schematic representation of the apparatus in accordance with the present invention;

FIG. 5 is a schematic representation of the pipe mounting of the temperature sensors in accordance with the present invention; and

FIG. 6 is a schematic representation of the data collection unit;

FIG. 7 is a schematic representation of the computer in accordance with the present invention.

### DETAILED DESCRIPTION OF PREFERRED EMBODIMENTS

In describing preferred embodiments of the invention, specific terminology will be selected for the sake of clarity. However, the invention is not intended to be limited to the specific terms so selected, and it is to be understood that each specific term includes all technical equivalents that operate in a similar manner to accomplish a similar purpose.

The terms “refrigeration system” and “HVAC&R system” are used throughout this document to refer in a broad sense to an apparatus or system utilizing a vapor compression cycle to work on a refrigerant in a closed-loop operation to transport heat. Accordingly, the terms “refrigeration system” and “HVAC&R system” include refrigerators, freezers, air conditioners, and heat pumps.

Preferred embodiments of the present invention will now be described in detail with reference to the accompanying drawings in which a device used to carry out the method in accordance with the present invention is generally indicated by reference numeral 200. The term “refrigeration cycle” referred to in this document usually refers to systems designed to transfer heat to and from air. These are called direct expansion (evaporator side) air cooled (condenser side) units. It will be understood by those in the art, after reading this description, that another fluid (e.g., water) can be substituted for air with the appropriate modifications to the terminology and heat exchanger descriptions.

The vapor compression cycle is the principle upon which conventional air conditioning systems, heat pumps, and refrigeration systems are able to cool (or heat for heat pumps) and dehumidify air in a defined volume (e.g., a living space, an interior of a vehicle, a freezer, etc.). The vapor-compression cycle is made possible because the refrigerant is a fluid that exhibits specific properties when it is placed under varying pressures and temperatures.

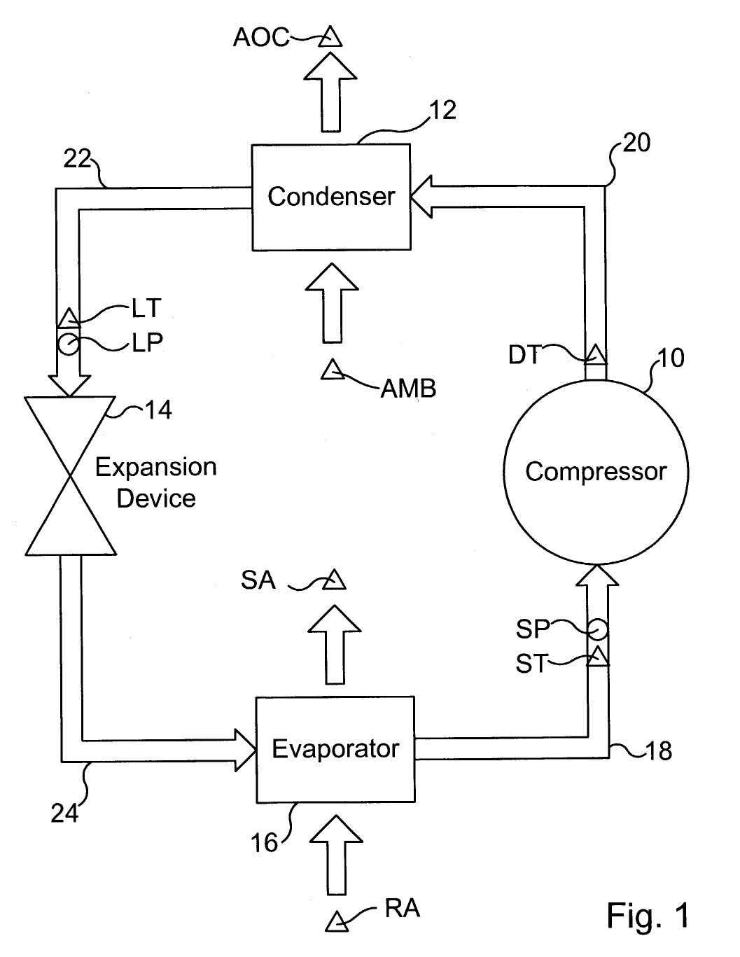

A typical refrigeration system 100 is illustrated in FIG. 1. The refrigeration system 100 is a closed loop system and includes a compressor 10, a condenser 12, an expansion device 14 and an evaporator 16. The various components are connected together via a conduit (usually copper tubing). A refrigerant continuously circulates through the four components via the conduit and will change state, as defined by its properties such as temperature and pressure, while flowing through each of the four components.

The refrigerant is a two-phase vapor-liquid mixture at the required condensing and evaporating temperatures. Some common types of refrigerant include R-12, R-22, R-134A, and R-410A. The main operations of a refrigeration system are compression of the refrigerant by the compressor 10, heat rejection by the refrigerant in the condenser 12, throttling of the refrigerant in the expansion device 14, and heat absorption by the refrigerant in the evaporator 16. This process is usually referred to as a vapor compression or refrigeration cycle.

In the vapor compression cycle, the refrigerant nominally enters the compressor 10 as a slightly superheated vapor (its temperature is greater than the saturated temperature at the local pressure) and is compressed to a higher pressure. The compressor 10 includes a motor (usually an electric motor) and provides the energy to create a pressure difference between the suction line and the discharge line and to force a refrigerant to flow from the lower to the higher pressure. The pressure and temperature of the refrigerant increases during the compression step. The pressure of the refrigerant as it enters the compressor is referred to as the suction pressure and the pressure of the refrigerant as it leaves the compressor is referred to as the head or discharge pressure. The refrigerant leaves the compressor as highly superheated vapor and enters the condenser 12.

A typical air-cooled condenser 12 comprises a single or parallel conduits formed into a serpentine-like shape so that a plurality of rows of conduit is formed parallel to each other. Metal fins or other aids are usually attached to the outer surface of the serpentine-shaped conduit in order to increase the transfer of heat between the refrigerant passing through the condenser and the ambient air. Heat is rejected from the refrigerant as it passes through the condenser and the refrigerant nominally exits the condenser as slightly subcooled liquid (its temperature is lower than the saturated temperature at the local pressure). As refrigerant enters a “typical” condenser, the superheated vapor first becomes saturated vapor in the approximately first quarter section of the condenser, and the saturated vapor undergoes a phase change in the remainder of the condenser at approximately constant pressure.

The expansion device 14, or metering device, reduces the pressure of the liquid refrigerant thereby turning it into a saturated liquid-vapor mixture at a lower temperature, to enter the evaporator. This expansion is a throttling process. In order to reduce manufacturing costs, the expansion device is typically a capillary tube or fixed orifice in small or low-cost air conditioning systems and a thermostatic expansion valve (TXV) or electronic expansion valve (EXV) in larger units. The TXV has a temperature-sensing bulb on the suction line. It uses that temperature information along with the pressure of the refrigerant in the evaporator to modulate (open and close) the valve to try to maintain proper compressor inlet conditions. The temperature of the refrigerant drops below the temperature of the indoor ambient air as it passes through the expansion device. The refrigerant enters the evaporator 16 as a low quality saturated mixture (approximately 20%). (“Quality” is defined as the mass fraction of vapor in the liquid-vapor mixture.)

A direct expansion evaporator 16 physically resembles the serpentine-shaped conduit of the condenser 12. Ideally, the refrigerant completely evaporates by absorbing energy from the defined volume to be cooled (e.g., the interior of a refrigerator). In order to absorb heat from this ambient volume, the temperature of the refrigerant must be lower than that of the volume to be cooled. Nominally, the refrigerant leaves the evaporator as slightly superheated gas at the suction pressure of the compressor and reenters the compressor thereby completing the vapor compression cycle. (It should be noted that the condenser 12 and the evaporator 16 are types of heat exchangers and are sometimes referred to as such in the following text.) Although not shown in FIG. 1, a fan driven by an electric motor is usually positioned next to the evaporator; a separate fan/motor combination is usually positioned next to the condenser. The fan/motor combinations increase the airflow over their respective evaporator or condenser coils, thereby increasing the transfer of heat. For the evaporator in cooling mode, the heat transfer is from the indoor ambient volume to the refrigerant circulating through the evaporator; for the condenser in cooling mode, the heat transfer is from the refrigerant circulating through the condenser to the outside air. A reversing valve is used by heat pumps operating in heating mode to properly reverse the flow of refrigerant, such that the outside heat exchanger (the condenser in cooling mode) becomes an evaporator and the indoor heat exchanger (the evaporator in cooling mode) becomes a condenser.

Finally, although not shown, is a control system that allows users to operate and adjust the desired temperature within the ambient volume. The most basic control system comprises a low voltage thermostat that is mounted on a wall inside the ambient volume, and relays that control the electric current delivered to the compressor and fan motors. When the temperature in the ambient volume rises above a predetermined value on the thermostat, a switch closes in the thermostat, forcing the relays to make and allowing current to flow to the compressor and the motors of the fan/motors combinations. When the refrigeration system has cooled the air in the ambient volume below the predetermined value set on the thermostat, the switch opens thereby causing the relays to open and turning off the current to the compressor and the motors of the fan/motor combination.

U.S. Pat. No. 6,324,854, titled AIR-CONDITIONING SERVICING SYSTEM AND METHOD issued Dec. 4, 2001, to Nagara, Jayanth, is hereby incorporated by reference as if fully set forth herein.

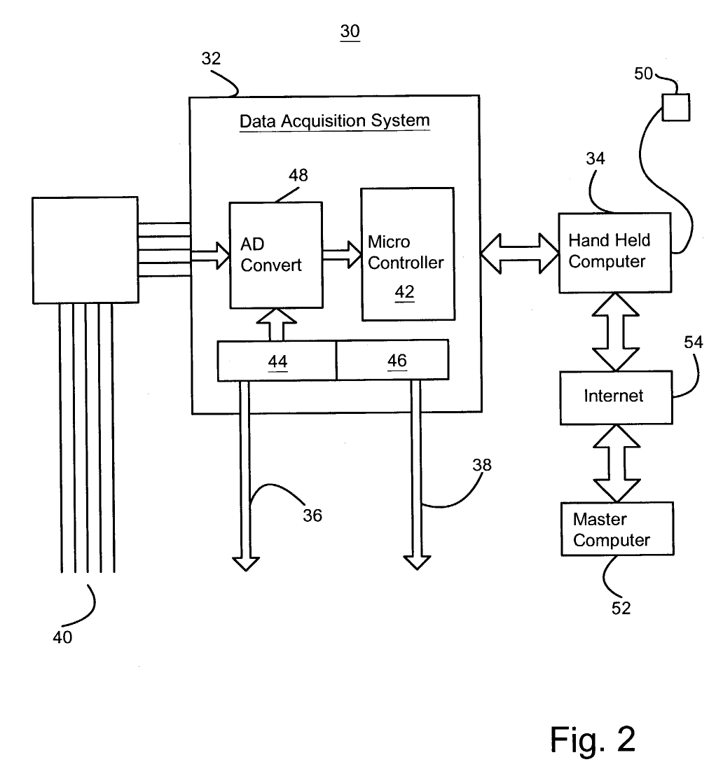

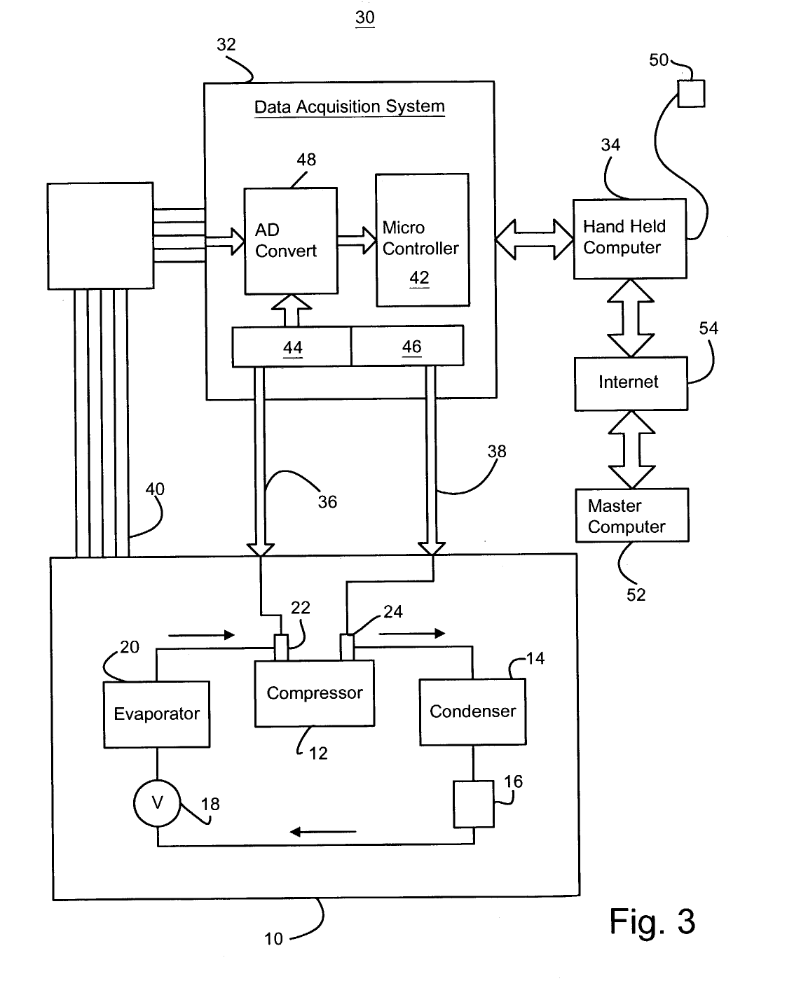

Referring now to FIGS. 2 and 3, an air-conditioning service system or apparatus 30 is illustrated. Apparatus 30 comprises a data acquisition system 32, a hand held computer 34, a pair of pressure hoses 36 and 38, and a plurality of sensors 40. Data acquisition system 32 includes a micro-controller 42, a pair of pressure sensors 44 and 46 and an Analog to Digital converter 48. Pressure hose 36 is adapted to be attached to port 22 to monitor the pressure at or near the suction port of compressor 12. Pressure hose 38 is adapted to be attached to port 24 to monitor the pressure at or near the discharge port of compressor 12. Each hose 36 and 38 is in communication with sensors 44 and 46, respectively, and each sensor 44 and 46 provides an analog signal to A/D converter 48 which is indicative of the pressure being monitored. A/D converter 48 receives the analog signal from sensors 44 and 46, converts this analog signal to a digital signal which is indicative of the pressure being monitored and provides this digital system to micro-controller 42.

Sensors 40 are adapted to monitor various operating characteristics of compressor 12. Several sensors 40 monitor specific temperatures in the system, on sensor monitors compressor supply voltage, one sensor monitors compressor supply amperage and one sensor monitors the rotational speed (RPM) for compressor 12. Typical temperatures that can be monitored include evaporator refrigerant temperature, condenser refrigerant temperature, ambient temperature and conditioned space temperature. The analysis of parameters like compressor voltage, compressor current, compressor RPM and discharge temperature can provide valuable information regarding the cause of the problem. Each sensor 40 is connected to A/D converter 48 and sends an analog signal indicative of its sensed parameter to A/D converter 48. A/D converter 48 receives the analog signals from sensors 40 and converts them to a digital signal indicative of the sensed parameter and provides this digital signal to micro-controller 42.

Micro-controller 42 is in communication with computer 34 and provides to computer 34 the information provided by micro-controller 42. Once computer 34 is provided with the air-conditioning system configuration and the sensed parameters from sensors 40, 44 and 46, a diagnostic program can be performed. The air-conditioning system configuration can be provided to computer 34 manually be the technician or it can be provided to computer 34 by a bar code reader 50 if the air-conditioning system is provided with a bar code label which sufficiently identifies the air-conditioning system.

In order for the diagnostic program to run, computer 34 must know what the normal parameters for the monitored air-conditioning system should be. This information can be kept in the memory of computer 34, it can be kept in the larger memory of a master computer 52 or it can be kept in both places. Master computer 52 can be continuously updated with new models and revised information as it becomes available. When accessing the normal parameters in its own memory, computer 34 can immediately use the saved normal parameters or computer 34 can request the technician to connect to master computer 52 to confirm and/or update the normal parameters. The connection to the master computer 52 is preferably accomplished through a wireless Internet connection 54 in order to simplify the procedure for the technician. Also, if the particular air conditioning system being monitored is not in the memory of computer 34, computer 34 can prompt the technician to connect to master computer 52 using wireless Internet connection 54 to access the larger data base which is available in the memory of master computer 52. In this way, computer 34 can include only the most popular systems in its memory but still have access to the entire population or air-conditioning systems through connection 54. While the present invention is being illustrated utilizing wireless Internet connection 54, it is within the scope of the present invention to communicate between computers 34 and 52 using a direct wireless or a wire connection if desired.

The technician using apparatus 30 would first hook up pressure hose 36 to port 22 and pressure hose 38 to port 24. The technician would then hook up the various temperature sensors 40, the compressor supply voltage and current sensors 40 and the compressor RPM sensor 40. The technician would then initialize computer 34 and launch the diagnostics application software. The software on start-up prompts the technician to set up the test session. The technician then picks various options such as refrigerant type of the system and the system configuration, like compressors and system model number, expansion device type or other information for the configuration system. Optionally this information can be input into computer 34 using a barcode label and barcode reader 50 if this option is available. The software then checks to see if the operating information for the system or the compressor model exists within its memory. If this information is not within its memory, computer 34 will establish a wireless connection to master computer 52 through wireless Internet connection 54 and access this information from master computer 52. Also, optionally, computer 34 can prompt the technician to update the existing information in its memory with the information contained in the memory of master computer 52 or computer 34 can prompt the technician to add the missing information to its memory from the memory of master computer 52.

Once the test session is set up, the software commands micro-controller 42 to acquire the sensed values from sensors 40, 44, and 46. Micro-controller 42 has its own custom software that verifies the integrity of the values reported by sensors 40, 44 and 46. An example would be that micro-controller 42 has the ability to detect a failed sensor. The sensors values acquired by micro-controller 42 through A/D converter 48 are reported back to computer 34. This cycle of sensor data is acquired continuously throughout the test session. The reported sensed data is then used to calculate a variety of system operating parameters. For example, superheat, supercooling, condensing temperature, evaporating temperature, and other operating parameters can be determined. The software within computer 34 then compares these values individually or in combination with the diagnostics rules programmed and then based upon these comparisons, the software derives a set of possible causes to the differences between the measured values and the standard operating values. The diagnostic rules can range from simple limits to fuzzy logic to trend analysis. The diagnostic rules can also range from individual values to a combination of values.

For example, the current drawn by compressor 12 is related to the suction and discharge pressures and is unique to each compressor model. Also, the superheat settings are unique to each air-conditioning system. Further, the diagnostic rules are different for different system configurations like refrigerant type, expansion device type, compressor type, unloading scheme, condenser cooling scheme and the like. In some situations, the application of the diagnostic rules may lead to the requirement of one or more additional parameters. For example, the diagnostic system may require the indoor temperature which may not be currently sensed. In this case, the technician will be prompted to acquire this valve by other means and to input its value into the program. When the criteria for a diagnostic rule have been satisfied, then a cause or causes of the problem is displayed to the technician together with solutions to eliminate the problem. For example, a high superheat condition in combination with several other conditions suggests a low refrigerant charge and the solution would be to add refrigerant to the system. The technician can then carry out the suggested repairs and then rerun the test. When the system is again functioning normally, the test results and the sensed values can be saved for future reference.

While sensors 40 are disclosed as being hard wired to A/D converter 48, it is within the scope of the preset invention to utilize wireless devices to reduce the number of wiring hookups that need to be made.

Also, while apparatus 30 is being disclosed as a diagnostic tool, it is within the scope of the present invention to include an automatic refrigerant charging capability through hoses 36 and 38 if desired. This would involve the addition of a control loop to meter refrigerant into the system from a charging cylinder. Accurate charging would be accomplished by continuously monitoring the system parameters during the charging process.

There are common degradation faults in systems that utilize a vapor compression cycle. For example, heat exchanger fouling and improper refrigerant charge both can result in performance degradations including reductions in efficiency and capacity. Low charge can also lead to high superheat at the suction line of the compressor, a lower evaporating temperature at the evaporator, and a high temperature at the compressor discharge. High charge, on the other/hand, increases the condensing and evaporating temperature. Degradation faults naturally build up slowly and repairing them is often a balance between the cost of servicing the equipment (e.g., cleaning heat exchangers) and the energy cost savings associated with returning them to optimum (or at least an increase in) efficiency.

The present invention is an effective apparatus and corresponding process for using measurements easily and commonly made in the field to:
Detect faults of a unit running in the field;
   1. Provide diagnostics that can lead to proper service in the field;
   2. Verify the performance improvement after servicing the unit; and
   3. Educate the technician on unit performance and diagnostics.
      The present invention is useful for:
1. Balancing the costs of service and energy, thereby permitting the owner/operator to make better informed decisions about when the degradation faults significantly impact operating costs such that they require attention or servicing.
2. Verifying the effectiveness of the service carried out by the field technicians to ensure that all services were performed properly.

The present invention is an apparatus and a corresponding method that detects faults and provides diagnostics in refrigeration systems operating in the field. The present invention is preferably carried out by a microprocessor-based system; however, various apparatus, hardware and/or software embodiments may be utilized to carry out the disclosed process. In effect, the apparatus of the present invention integrates two standard technician hand tools, a mechanical manifold gauge set and a multi-channel digital thermometer, into a single unit, while providing sophisticated user interface implemented in one embodiment by a computer. The computer comprises a microprocessor for performing calculations, a storage unit for storing the necessary programs and data, means for inputting data and means for conveying information to a user/operator. In other embodiments, the computer includes one or more connectors for assisting in the direct transfer of data to another computer that is usually remotely located.

Although any type of computer can be used, a hand-held computer allows portability and aids in the carrying of the diagnostic apparatus to the field where the refrigeration system is located. Therefore, the most common embodiments of a hand-held computer include the Palm Pilot manufactured by 3COM, a Windows CE based unit (for example, one manufactured by Compaq Computers of Houston, Tex.), or a custom computer that comprises the aforementioned elements that can carry out the requisite software instructions. If the computer is a Palm Pilot, the means for inputting data is a serial port that is connected to a data collection unit and the touchpad/keyboard that is standard equipment on a Palm. The means for conveying information to a user/operator is the screen or LCD, which provides written instructions to the user/operator.

Preferably, the apparatus consists of three temperature sensors and two pressure sensors. The two pressure sensors are connected to the unit under test through the suction line and liquid line ports, which are made available by the manufacturer in most units, to measure the suction line pressure SP and the liquid line pressure LP. The connection is made through the standard red and blue hoses, as currently performed by technicians using a standard mechanical manifold. The temperature sensors are thermistors. Two of them measure the suction line temperature ST and the liquid line temperature LT, by attaching them to the outside of the copper pipe at each of these locations, as near as possible to the pressure ports.

A feature of the present invention is that the wires connecting the temperature sensors ST and LT to the data collection unit are attached to the blue and red hoses, respectively, of the manifold. Thus, there is no wire tangling and the correct sensor is easily identified with each hose. The remaining temperature sensor is used to measure the ambient air temperature AMB. These five sensors are easily installed and removed from the unit and do not have to be permanently installed in the preferred embodiment of the invention. This feature allows for the portability of the apparatus, which can be used in multiple units in a given job.

Although these five measurements are sufficient to provide fault detection and diagnostics in the preferred embodiment, four additional temperatures can optionally be used to obtain more detailed performance analysis of the system under consideration. These four additional temperatures are: supply air SA, return air RA, discharge line DT, and air off condenser AOC. All the sensor positions, including the optional, are shown in FIG. 1.

Referring again to FIG. 1, the pressure drop in the tubes connecting the various devices of a vapor compression cycle is commonly regarded as negligible; therefore, the important states of a vapor compression cycle may be described as follows:
State 1: Refrigerant leaving the evaporator and entering the compressor. (The tubing connecting the evaporator and the compressor is called the suction line 18.)
State 2: Refrigerant leaving the compressor and entering the condenser (The tubing connecting the compressor to the condenser is called the discharge or hot gas line 20).
State 3: Refrigerant leaving the condenser and entering the expansion device. (The tubing connecting the condenser and the expansion device is called the liquid line 22).
State 4: Refrigerant leaving the expansion device and entering the evaporator (connected by tubing 24).

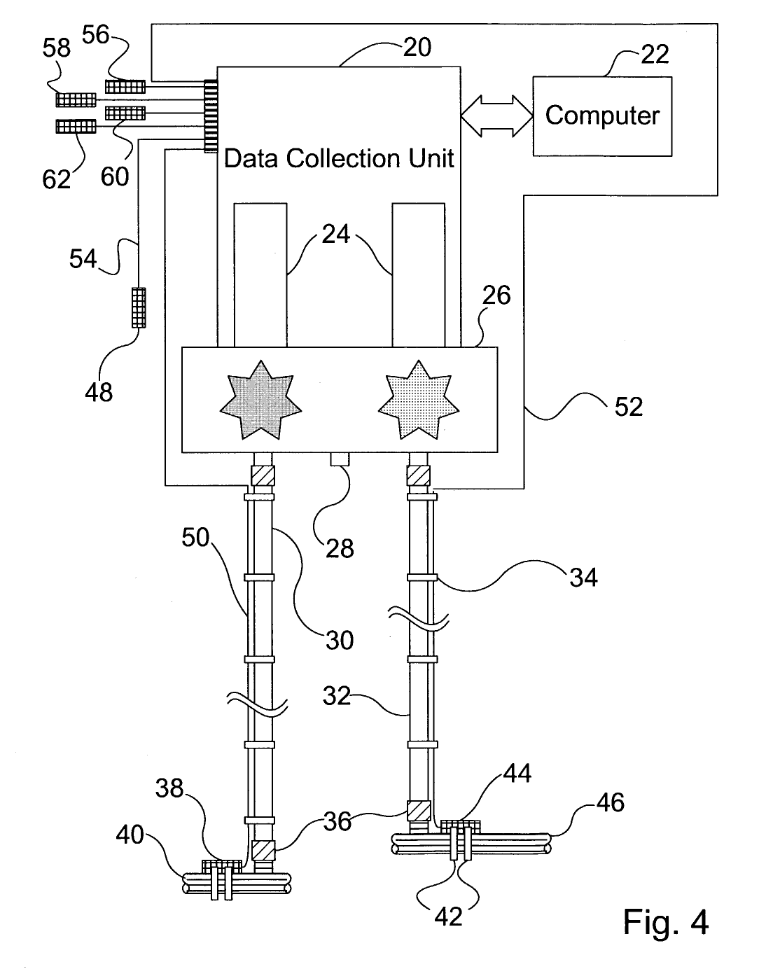

A schematic representation of the apparatus is shown in FIG. 4. The data collection unit 20 is connected to a computer 22. The two pressure transducers (the left one for suction line pressure SP and the right one for liquid line pressure LP) 24 are housed with the data collection unit 20 in the preferred embodiment. The temperature sensors are connected to the data collection unit through a communication port shown on the left of the data collection unit. The three required temperatures are ambient temperature (AMB) 48, suction line temperature (ST) 38, and liquid line temperature (LT) 44. The optional sensors measure the return air temperature (RA) 56, supply air temperature (SA) 58, discharge temperature (DT) 60, and air off condenser temperature (AOC) 62.

In one embodiment, the computer is a handheld computer, such as a Palm™ OS device and the temperature sensors are thermistors. For a light commercial refrigeration system, the pressure transducers should have an operating range of 0 to =700 psig and −15 to 385 psig for the liquid and suction line pressures, respectively. The apparatus can then be used with the newer high-pressure refrigerant R-410a as well as with traditional refrigerants such as R-22.

The low-pressure sensor is sensitive to vacuum to allow for use when evacuating the system. Both pressure transducers are connected to a mechanical manifold 26, such as the regular manifolds used by service technicians, to permit adding and removing charge from the system while the apparatus is connected to the unit. Two standard refrigerant flow control valves are available at the manifold for that purpose.

At the bottom of the manifold 26, three access ports are available. As illustrated in FIG. 4, the one on the left is to connect to the suction line typically using a blue hose 30; the one in the middle 28 is connected to a refrigerant bottle for adding charge or to a recovery system for removing charge typically using a yellow hose; and the one on the right is connected to the liquid line through a red hose 32. The three hoses are rated to operate with high pressures, as it is the case when newer refrigerants, such as R-410a, are used. The lengths of the hoses are not shown to scale in FIG. 4. At the end of the pressure hoses, there are pressure ports to connect to the unit pipes 40 and 46, respectively. The wires, 50 and 52 respectively, leading to the suction and liquid line temperature sensors are attached to the respective pressure hoses using wire ties 34 to avoid misplacing the sensors. The suction and liquid line pipes, 40 and 46, respectively, are shown to provide better understanding of the tool's application and are not part of the apparatus. The suction and liquid line temperature sensors, 38 and 44 respectively, are attached to the suction and liquid line pipes using an elastic mounting 42.

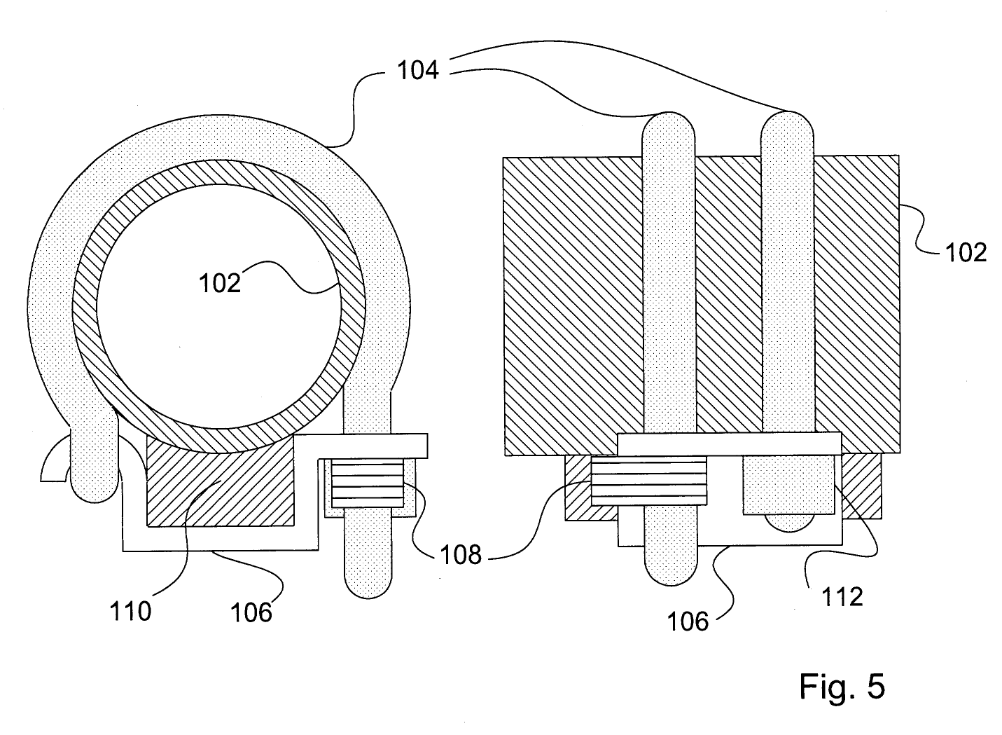

The details of the mounting of the temperature sensor on the pipe are shown in FIG. 5. It is assumed that the temperature of the refrigerant flowing through the pipe 102 is equal to the outside temperature of the pipe. Measuring the actual temperature of the refrigerant requires intrusive means, which are not feasible in the field. To measure the outside temperature of the pipe, a temperature sensor (a thermistor) needs to be in good contact with the pipe. The pipes used in HVAC&R applications vary in diameter. As an alternative, in another embodiment of the present invention, the temperature sensor 110 is securely placed in contact with the pipe using an elastic mounting. An elastic cord 104 is wrapped around the pipe 102, making a loop on the metallic pipe clip 106. A knot or similar device 112 is tied on one end of the elastic cord, secured with a wire tie. On the other end of the elastic cord, a spring loaded cord lock 108 is used to adjust and secure the temperature sensor in place for any given pipe diameter. Alternatively, temperature sensors can be secured in place using pipe clips as it is usually done in the field.

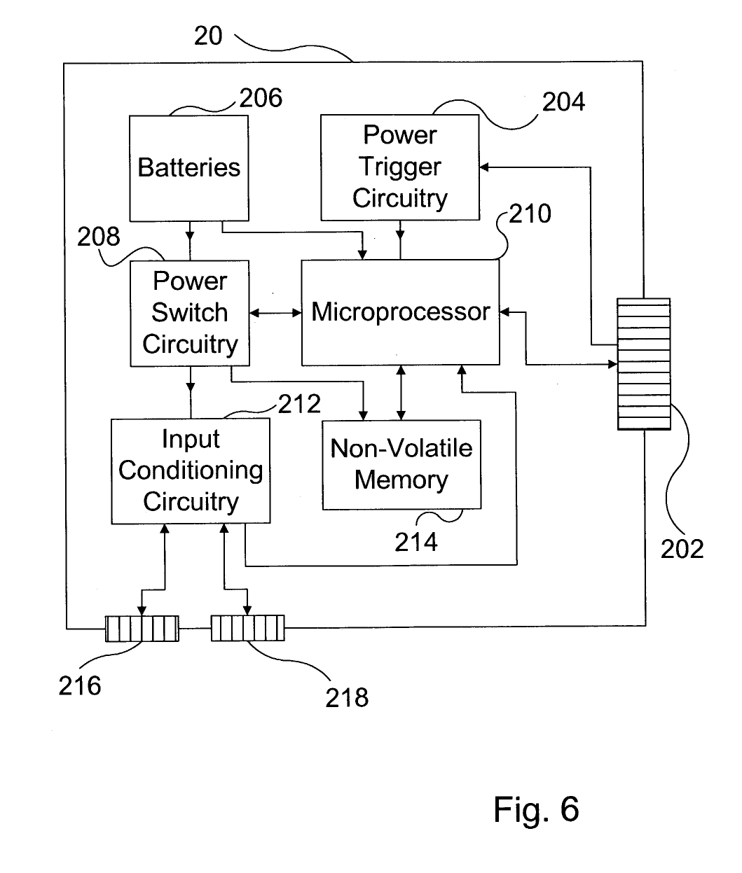

Referring now to FIG. 6, the data collection unit 20 comprises a microprocessor 210 and a communication means. The microprocessor 210 controls the actions of the data collection unit, which is powered by the batteries 206. The batteries also serve to provide power to all the parts of the data collection unit and to excite the temperature and pressure sensors. The software is stored in a non-volatile memory (not shown) that is part of the microprocessor 210. A separate non-volatile memory chip 214 is also present. The data collection unit communicates with the handheld computer through a bi-directional communication port 202. In one embodiment, the communication port is a communication cable (e.g., RS232), through the serial communication connector. The temperature sensors are connected to the data collection unit through a port 216, and connectors for pressure transducers 218 are also present. In the preferred embodiment of the invention, the pressure transducers are housed with the data collection unit. Additional circuits are present in the preferred embodiment. Power trigger circuitry 204 responds to the computer to control the process of turning on the power from the batteries. Power switch circuitry 208 controls the power from the batteries to the input conditioning circuitry 212, the non-volatile memory 214 and the microprocessor 210. Input conditioning circuitry 212 protects the microprocessor from damaging voltage and current from the sensors.

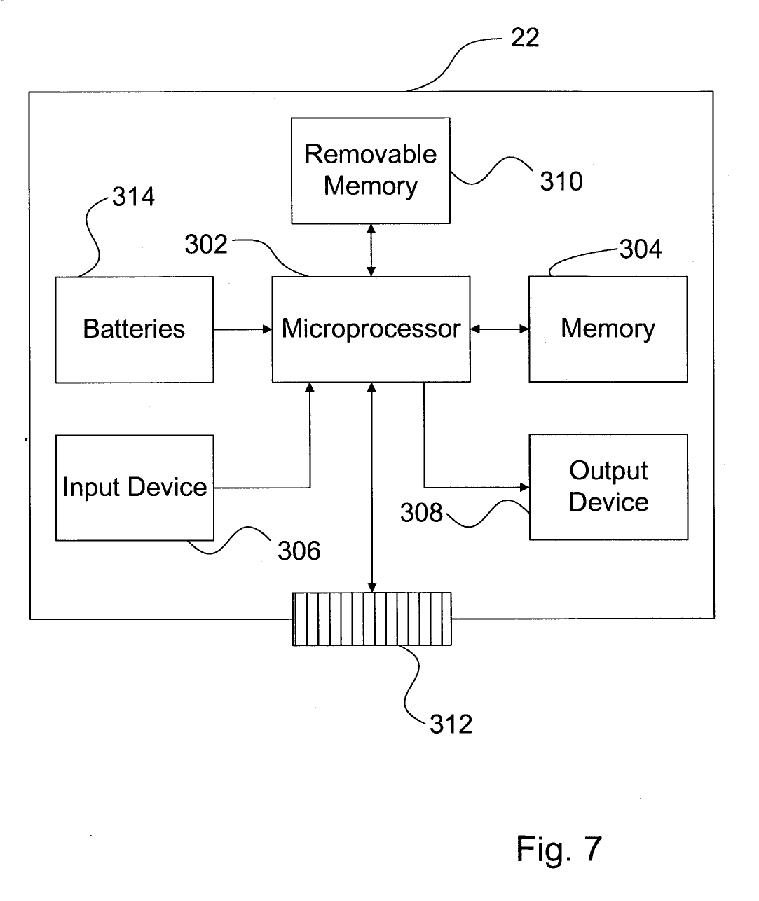

A schematic diagram of the computer is shown in FIG. 7. The computer, preferably a handheld device, has a microprocessor 302 that controls all the actions. The software, the data, and all the resulting information and diagnostics are stored in the memory 304. The technician provides information about the unit through an input device (e.g. keyboard or touchpad) 306, and accesses the measurements, calculated parameters, and diagnostics through an output device (e.g. LCD display screen) 308. The computer is powered by a set of batteries 314. A non-volatile removable memory 310 is present to save important data, including the software, in order to restore the important settings in case of power failure.

The invention can be used in units using several refrigerants (R-22, R-12, R-500, R-134a, and R-410a). The computer prompts (through LCD display 308) the technician for the type of refrigerant used by the refrigeration system to be serviced. The technician selects the refrigerant used in the unit to be tested prior to collecting data from the unit. The implementation of a new refrigerant requires only programming the property table in the software. The computer also prompts (again through LCD display 308) the technician for the type of expansion device used by the refrigeration system. The two primary types of expansion devices are fixed orifice or TXV. After the technician has answered both prompts, the fault detection and diagnostic procedure can start.

The process will now be described in detail with respect to a conventional refrigeration cycle. FIGS. 8A-8F is a combined flowchart/schematic block diagram of the main steps of the present invention utilizing five field measurements. As described above, various gauges and sensors are known to those skilled in the art that are able to take the five measurements. Also, after reading this description, those skilled in the art will understand that more than five measurements may be taken in order to determine the efficiency and the best course of action for improving the efficiency of the refrigeration system.

The method consists of the following steps:
A. Measure high and low side refrigerant pressures (LP and SP, respectively); measure the suction and liquid line temperatures (ST and LT, respectively); and measure the outdoor atmospheric temperature (AMB) used to cool the condenser. These five measurements are all common field measurements that any refrigeration technician can make using currently available equipment (e.g., manifold pressure gauges, thermometers, etc.). If sensors are available, also measure the discharge temperature (DT), the return air temperature (RA), the supply air temperature (SA), and the air off condenser temperature (AOC). These measurements are optional, but they provide additional insight into the performance of the vapor compression cycle. (As stated previously, these are the primary nine measurements—five required, four optional—that are used to determine the performance of the HVAC unit and that will eventually be used to diagnose a problem, if one exists.) Use measurements of LP and LT to accurately calculate liquid line subcooling, as it will be shown in step B. Use the discharge line access port to measure the discharge pressure DP when the liquid line access port is not available. Even though the pressure drop across the condenser results in an underestimate of subcooling, assume LP is equal to DP or use data provided by the manufacturer to estimate the pressure drop and determine the actual value of LP.
B. Calculate the performance parameters (pressure difference, condensing temperature over ambient, evaporating temperature, suction line superheat, and liquid line subcooling) that are necessary for the fault detection and diagnostic algorithm.
   B.1 Use the liquid pressure (LP) and the suction pressure (SP) to calculate the pressure difference (PD), also known as the expansion device pressure drop
      PD=LP−SP.
   B.2 Use the liquid line temperature (LT), liquid pressure (LP), outdoor air ambient temperature (AMB), and air of condenser temperature (AOC) to determine the following condenser parameters:
      i) the condensing temperature (CT)
         CT=Tₛₐₜ(LP),
      ii) the liquid line subcooling (SC)
         SC=CT−LT,
      iii) the condensing temperature over ambient (CTOA)
         CTOA=CT−AMB,
iv) the condenser temperature difference (CTD), if AOC is measured
   CTD=AOC−AMB.
   B.3 Use the suction line temperature (ST), suction pressure (SP), return air temperature (RA), and supply air temperature (SA) to determine:
      i) the evaporating temperature (ET):
         ET=Tₛₐₜ(SP),
      ii) the suction line 59d superheat (SH):
         SH=ST−ET
      iii) the evaporator temperature difference (ETD), if RA and SA are measured:
         ETD=RA−SA.

C. Define the operating ranges for the performance parameters. The operating range for each performance parameter is defined by up to 3 values; minimum, goal, and maximum. Table 1 shows an example of operating limits for some of the performance parameters. The operating ranges for the superheat (SH) are calculated by different means depending upon the type of expansion device. For a fixed orifice unit, use the manufacturer's charging chart and the measurements to determine the manufacturer's suggested superheat. For units equipped with a thermostatic expansion valve (TXV) the superheat is fixed: for air conditioning applications use 20° F.

TABLE 1
Example of Operating Ranges for Performing Indices

| Symbol | Description | Minimum | Goal | Maximum |
|---|---|---|---|---|
| CTOA (° F.) | Condensing over Ambient | — | 20 | 30 |
| | Temperature Difference | | | |
| ET (° F.) | Evaporating Temperature | 30 | 40 | 47 |
| PD (psi) | Pressure Difference | 100 | — | — |
| SC (° F.) | Liquid Line Subcooling | 6 | 12 | 20 |
| SH (° F.) | Suction Line Superheat | 12 | 20 | 30 |
| CTD (° F.) | Condenser Temperature | — | — | 30 |
| | Difference | | | |
| ETD (° F.) | Evaporator Temperature | 17 | 20 | 26 |
| | Difference | | | |

For the evaporating temperature (ET), there is also a VERY HI limit, which, for example, can be equal to 55° F. Note that the values presented illustrate the concept and may vary depending on the actual system investigated. For example, the suction line superheat expectation for units equipped with fixed orifice expansion devices varies with the load.
D. A level is assigned to each performance parameter. Levels are calculated based upon the relationship between performance parameters and the operating range values. The diagnostic routine utilizes the following 4 levels: Low (LO), Below Goal, Above Goal, and High (HI). A performance parameter is High if its value is greater than the maximum operating limit. The evaporating temperature has also a MMaximum level, so if ET is higher than Mmaximum, its level is Very Hi. It is Above Goal if it the value is less than the maximum limit and greater than the goal. The performance parameter is Below Goal if the value is less than the goal but greater than the low limit. Finally, the parameter is Low if the value is less than the minimum. The following are generally accepted rules, which determine the operating regions for air conditioners, but similar rules can be written for refrigerators and heat pumps:
   D.1 The limits for evaporating temperature (ET) define two boundaries: a low value leads to coil freezing and a high value leads to reduced latent cooling capacity.
   D.2 The maximum value of the condensing temperature over ambient difference (CTOA) defines another boundary: high values lead to low efficiency. Note that a high value is also supported by high condenser temperature difference (CTD).
   D.3 The minimum value of the pressure drop (PD) defines another boundary. A lower value may prevent the TXV from operating properly.
   D.4 Within the previously defined boundaries, suction superheat (SH) and liquid subcooling (SC) provides a sense for the amount of refrigerant on the low and high sides, respectively. A high value of suction superheat leads to insufficient cooling of hermetically sealed compressors and a low value allows liquid refrigerant to wash oil away from moving parts inside the compressor. A high or low liquid subcooling by itself is not an operational safety problem, but it is important for diagnostics and providing good operating efficiency. Low SC is often associated with low charge.
E. The fault detection aspect of the present invention determines whether or not service is required, but does not specify a particular action. Faults are detected based upon a logic tree using the levels assigned to each performance parameter. If the following conditions are satisfied, the cycle does not need service:
   E.1 Condenser temperature (CT) is within the limits as determined by:
      i) The cycle pressure difference (PD) is not low.
      ii) The condensing temperature over ambient (CTOA) is not high.
      iii) The condenser temperature difference (CTD) is not high
   E.2 Evaporator temperature (ET) is neither low nor high.
   E.3 Compressor is protected. This means the suction line superheat (SH) is within neither low nor high.

If any of these performance criteria is not satisfied, there must be a well define course of action to fix the problem

F. Similar to the fault detection procedure, diagnoses are made upon a logic tree using the levels assigned to each performance parameter. Table 1 shows the conditions and the diagnostics for each case when a fault is present.

TABLE 1
Diagnostics Conditions

| Condition | Diagnostics |
|---|---|
| CTOA > HI, SC > HI | Overcharged unit |
| CTOA > HI, SC < HI | High side heat transfer problem |
| ET > VERY HI | Inefficient compressor |
| ET > HI, SH < Goal | Too fast evaporator fan |
| ET > HI, SH < GOAL, SC > GOAL | Too fast evaporator fan and |
| | overcharged unit |
| ET > HI, SH < GOAL, SC < GOAL | Difficult diagnostics |
| ET < LO, SH > HI, SC > GOAL | Check for flow restriction |
| ET < LO, SH > HI, SC < GOAL | Undercharged unit |
| ET < LO, SH < LO | Low side heat transfer problem |
| ET < LO, LO < SH < HI | Low side heat transfer problem |
| | and undercharged unit |
| CTOA < HI, LO < ET < HI, SH > HI, | Check for flow restriction |
| SC > HI | |
| CTOA < HI, LO < ET < HI, SH > HI, | Undercharged unit |
| SC < LO | |
| CTOA < HI, LO < ET < GOAL, | Undercharged unit |
| LO < SC < HI | |
| CTOA < HI, GOAL < ET < HI, | Fast evaporator fan |
| LO < SC < HI | |
| CTOA < HI, LO < ET < HI, SH < LO, | Overcharged unit |
| SC > HI | |
| CTOA < HI, LO < ET < HI, SH < LO, | Difficult diagnostics |
| SC < LO | |
| CTOA < HI, LO < ET < HI, SH < LO, | Low side heat transfer problem |
| LO < SC < HI | |
| CTOA < HI, LO < ET < HI, | Low side heat transfer problem |
| LO < SH < HI, SC < LO | and undercharged unit |

Although the preferred embodiment of the present invention requires measuring three temperatures and two pressures, one skilled in the art will recognize that the two pressure measurements may be substituted by measuring the evaporating temperature (ET) and the condensing temperature (CT). The suction line pressure (SP) and the liquid line pressure (LP) can be calculated as the saturation pressures at the evaporating temperature (ET) and at the condensing temperature (CT), respectively.

Although this invention has been described and illustrated by reference to specific embodiments, it will be apparent to those skilled in the art that various changes and modifications may be made that clearly fall within the scope of this invention. The present invention is intended to be protected broadly within the spirit and scope of the appended claims.

We claim:

1. An apparatus for servicing a malfunctioning air-conditioning system including an electric motor, said apparatus comprising:
a first sensor for sensing a first operating parameter of said malfunctioning air-conditioning system;
a second sensor for sensing a second operating parameter of said malfunctioning air-conditioning system;
a third sensor for sensing a motor operating parameter of said malfunctioning air-conditioning system;
a micro-controller in communication with said sensors for receiving a signal from each of said sensors;
a hand held computer in communication with said micro-controller, said computer having a memory containing normal operating parameters for a plurality or air-conditioning systems, said computer being operable to compare said first, second and motor operating parameters with said normal parameters of one of said plurality of air-conditioning systems to diagnose said malfunctioning air-conditioning system.

2. The apparatus for servicing a malfunctioning air-conditioning system in accordance with claim 1, wherein said operating parameter is a low side pressure of said malfunctioning air-conditioning system, said second operating parameter is a high side pressure of said malfunctioning air-conditioning system and said third operating parameter is a supply voltage to a compressor of said malfunctioning air-conditioning system.

3. The apparatus for servicing a malfunctioning air-conditioning system in accordance with claim 1, wherein said first operating parameter is a low side pressure of said malfunctioning air conditioning system, said second operating parameter is a high side pressure of said malfunctioning air-conditioning system and said third operating parameter is a supply amperage to a compressor of said malfunctioning air-conditioning system.

4. The apparatus for servicing a malfunctioning air-conditioning system in accordance with claim 1, wherein said first operating parameter is a low side pressure of said malfunctioning air-conditioning system, said second operating parameter is a high side pressure of said malfunctioning air-conditioning system and said third operating parameter is a rotational speed of a compressor of said malfunctioning air-conditioning system.

5. The apparatus for servicing a malfunctioning air-conditioning system in accordance with claim 1, wherein said first operating parameter is a low side pressure of said malfunctioning air-conditioning system, said second operating parameter is a high side pressure of said malfunctioning air-conditioning system and said third operating parameter is a temperature of refrigerant in an evaporator of said malfunctioning air-conditioning system.

6. The apparatus for servicing a malfunctioning air-conditioning system in accordance with claim 1, wherein said first operating parameter is a low side pressure of said malfunctioning air-conditioning system, said second operating parameter is a high side pressure of said malfunctioning air-conditioning system and said third operating parameter is a temperature of refrigerant in a condenser of said malfunctioning air-conditioning system.

7. The apparatus for servicing a malfunctioning air-conditioning system in accordance with claim 1, wherein said first operating parameter is a supply amperage to a compressor of said malfunctioning air-conditioning system, said second operating parameter is a supply voltage to said compressor and said third operating parameter is a rotational speed of said compressor.

8. The apparatus for servicing a malfunctioning air-conditioning system in accordance with claim 1, further comprising:
a master computer disposed remote from said hand held computer; and
a wireless connection between said hand held computer and said master computer.

9. The apparatus for servicing a malfunctioning air-conditioning system in accordance with claim 8, wherein said wireless connection includes a connection to the Internet.

10. The apparatus for servicing a malfunctioning air-conditioning system in accordance with claim 1, wherein said computer provides instructions for repairing said malfunctioning air-conditioning system.

11. The apparatus for servicing a malfunctioning air-conditioning system in accordance with claim 1, further comprising a barcode reader in communication with said hand held computer.

12. A method for servicing a malfunctioning air-conditioning system including an electric motor, said method comprising:
measuring a first operating parameter of said malfunctioning air-conditioning system;
measuring a second operating parameter of said malfunctioning air-conditioning system;
measuring a motor operating parameter of said malfunctioning air-conditioning system;
providing said operating parameters to a hand held computer;
selecting one air conditioning system from a plurality of air-conditioning systems which is equivalent to said malfunctioning air-conditioning system;
comparing normal operating parameters of said one air-conditioning system with said operating parameters of said malfunctioning air-conditioning system; and
providing diagnostic results for said comparing step.

13. The method for servicing a malfunctioning air-conditioning system in accordance with claim 12, wherein said selecting step includes manual inputting an identifier of said malfunctioning air-conditioning system.

14. The method for servicing a malfunctioning air-conditioning system in accordance with claim 12, wherein said selecting step includes inputting an identifier of said malfunctioning air-conditioning system with a barcode reader.

15. The method for servicing a malfunctioning air-conditioning system in accordance with claim 12, wherein said selecting step includes communicating between said hand held computer and a master computer using a wireless connection.

16. The method for servicing a malfunctioning air-conditioning system in accordance with claim 15, wherein said communicating between said hand held computer and said master computer using a wireless connection includes communicating through the Internet.

17. The method for servicing a malfunctioning air-conditioning system in accordance with claim 12, wherein said providing diagnostic results includes providing instructions for repairing said malfunctioning air-conditioning system.

18. The method for servicing a malfunctioning air-conditioning system in accordance with claim 12, further comprising performing a test session prior to comparing said normal operating parameters with said operating parameters of said malfunctioning air-conditioning system.

19. The method for servicing a malfunctioning air-conditioning system in accordance with claim 12, further comprising updating said hand held computer from a master computer through a wireless connection.

20. The method for servicing a malfunctioning air-conditioning system in accordance with claim 12, further comprising measuring a fourth operating parameter of said malfunctioning air-conditioning system.
